(19) United States
(12) Patent Application Publication
(10) Pub. No.: US 2017/0286195 A1
(43) Pub. Date: Oct. 5, 2017

(54) INFORMATION OBJECT SYSTEM

(71) Applicant: SYSTEMIC MANAGEMENT SCIENCE CORPORATION, CHARLOTTESVILLE, VA (US)

(72) Inventor: JAE W. PAK, CHARLOTTESVILLE, VA (US)

(21) Appl. No.: 15/509,611

(22) PCT Filed: Sep. 11, 2014
(86) PCT No.: PCT/US14/55163

§ 371 Date: Mar. 8, 2017

(51) Int. Cl. G06F 9/54

(52) U.S. Cl. CPC G06F 9/546; G06F 9/547

(57) ABSTRACT

Disclosed are various embodiments for managing an information object system. Information objects may be created in response to receiving a request to store data. Information objects may be modified in response to receiving a request to modify one or more of the information objects. Further, copies of information objects may be provided in response to receiving a request for the information objects.

### RELATED APPLICATIONS

This application is related to U.S. patent application Ser. No. 14/208,346, entitled “Visualization Interface for Information Object System,” filed on Mar. 13, 2014, and which is incorporated by reference herein in its entirety.

### FEDERALLY SPONSORED RESEARCH

This invention was made with Government support under Contract No. W31P4Q-10-C-0010, awarded by the Defense Advanced Research Projects Agency (“DARPA”). The Government has certain rights in the invention.

### BACKGROUND

Many programs save data in a format specific to a particular program. In order for a program to process data outputted by another program, the program must be able to process data in the format specific to the other program.

### SUMMARY

Disclosed are various techniques for storing information in a machine and application independent manner. Data is stored as a collection of information objects. Applications can generate, store, and access information objects, including information objects generated by other applications or devices.

In an embodiment, a non-transitory computer-readable medium embodying a program executable in at least one computing device is

provided, the program comprising: code that creates an information object in response to receiving a request to store data from an application, wherein the request to store data comprises a first file and a first file type, or a data stream and an identification of a data source for the data stream and the information object is created based at least in part on the first file type or the identification of the data source; code that modifies the information object in response to receiving a request to modify the information object from the application, wherein the information object is locked while the information object is modified; code that provides a copy of the information object to the application in response to receiving a request for the information object from the application; and code that exports the information object to a second file in response to receiving a request to export the information object, wherein the request to export the information object specifies a second file type for the second file. In any one or more embodiments, the information object encapsulates: content data comprising a plurality of attributes related to the information object and a reference to another information object; form data describing how the information object is to be rendered within a user interface of the application; and a function for manipulating the information object. In any one or more embodiments, the first file and the first file type are associated with a first application and the second file and the second file type are associated with a second application.

In an embodiment, a system is provided, the system comprising: a computing device; and a first application executed in the computing device, the application comprising: logic that creates an information object in response to receiving a request to store data from a second application; logic that modifies the information object in response to receiving a request to modify the information object from the second application; and logic that provides a copy of the information object to the second application in response to receiving a request for the information object from the second application. In any one or more embodiments, the information object comprises content data, the content data comprising at least one of an attribute related to the information object or a reference to another information object. In any one or more embodiments, the information object comprises form data describing how the information object is to be rendered within a user interface of a client application executing on another computing device. In any one or more embodiments, the information object comprises a function for manipulating the information object, wherein the function may be invoked by either the application or a client application executing within a client computing device. In any one or more embodiments, the logic that modifies the information object invokes the function of the information to modify the information object. In any one or more embodiments, the logic that provides a copy of the information object to the second application in response to receiving a request for the information object from the second application further comprises: logic that determines whether the information object is located in a memory of the computing device; logic that provides the information object to the second application in response to determining that the information object is located in the memory of the computing device; and logic that sends a query to a third application executing in another computing device in response to determining that the information object is not located in the memory of the computing device, wherein the query requests that the third application determine whether the information object is located in a memory of the second computing device. In any one or more embodiments, the logic that provides a copy of the information object to the second application in response to receiving a request for the information object from the second application further comprises: logic that retrieves the information object from the another computing device when the third application responds to the query with an indication that the information object is located in the memory of the second computing device; and logic that provides the information object to the second application in response to retrieving the information object from the another computing device. In any one or more embodiments, the logic that provides a copy of the information object to the second application in response to receiving a request for the information object from the second application further comprises: logic that provides the second application with a location of the information object when the third application responds to the query with an indication that the information object is located in the memory of the second computing device.

In an embodiment, a method is provided, the method comprising: creating, via a computing device, an information object in response to receiving a request to store data from an application; modifying, via the computing device, the information object in response to receiving a request to modify the information object from the application; and providing a copy of the information object, via the computing device, to the application in response to receiving a request for the information object from the application. In any one or more embodiments, the request to store data comprises a file and a file type. In any one or more embodiments, creating, via the computing device, the information object in response to receiving the request to store data from the application further comprises: identifying, via the computing device, a rule for creating the information object, wherein the rule corresponds to the file type; creating, via the computing device, the information object according to the rule; and copying, via the computing device, data from the file into the created information object. In any one or more embodiments, the request to store data comprises a stream of data. In any one or more embodiments, creating, via the computing device, the information object in response to receiving the request to store data from the application further comprises: identifying, via the computing device, a data source for the stream of data; and creating, via the computing device, a plurality of information objects based at least in part on the data source, wherein each one of the plurality of information objects encapsulates at least a portion of the stream of data. In any one or more embodiments, the information object encapsulates at least one of: content data comprising a plurality of attributes related to the information object and a reference to another information object; form data describing how the information object is to be rendered within a user interface an application; or a function for manipulating the information object. In any one or more embodiments, providing the copy of the information object, via the computing device, to the application in response to receiving the request for the information object from the application further comprises: determining, via the computing device, a data store in which the information object is currently stored; and providing, via the computing device, a path to the data store to the application. In any one or more embodiments, the method further comprises exporting, via the computing device, the information object to a file in response to receiving a request from the application to export the information object to the file. In any one or more embodiments, exporting, via the computing device, the information object to the file in response to receiving the request from the application to export the information object to the file further comprises: identifying, via the computing device, a target file type of the file; identifying, via the computing device, a rule for converting the information object to the target file type; creating, via the computing device, the file; and copying, via the computing device, a least a portion of content encapsulated within the information object from the information object to the created file.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a networked environment according to various embodiments of the present disclosure.

FIG. 2 is a drawing of an Information Object as depicted in the networked environment of FIG. 1 according to various embodiments of the present disclosure.

FIG. 3 is a flowchart illustrating one example of functionality implemented as portions of a collaboration server executed in a computing environment in the networked environment of FIG. 1 according to various embodiments of the present disclosure.

FIG. 4 is a flowchart illustrating one example of functionality implemented as portions of a collaboration server executed in a computing environment in the networked environment of FIG. 1 according to various embodiments of the present disclosure.

FIG. 5 is a flowchart illustrating one example of functionality implemented as portions of a collaboration server executed in a computing environment in the networked environment of FIG. 1 according to various embodiments of the present disclosure.

FIG. 6 is a flowchart illustrating one example of functionality implemented as portions of a collaboration server executed in a computing environment in the networked environment of FIG. 1 according to various embodiments of the present disclosure.

FIG. 6 is a flowchart illustrating one example of functionality implemented as portions of a collaboration server executed in a computing environment in the networked environment of FIG. 1 according to various embodiments of the present disclosure.

FIG. 8 is a schematic block diagram that provides one example illustration of a computing environment employed in the networked environment of FIG. 1 according to various embodiments of the present disclosure.

### DETAILED DESCRIPTION

The present disclosure involves various embodiments for providing a universal data storage format. Data is stored in various information objects, which may include one or more nested information objects, information primitives, attributes, and/or other data. Each information object may also include form information detailing how an information object is best displayed to a user through a user interface as well as function information describing and/or defining a set of behaviors or program functions provided by the information object. In some embodiments, data may be imported into information objects from various data and/or file types. In some embodiments, data may also be exported from information objects into various data and/or file types. In the following discussion, a general description of the system and its components is provided, followed by a discussion of the operation of the same.

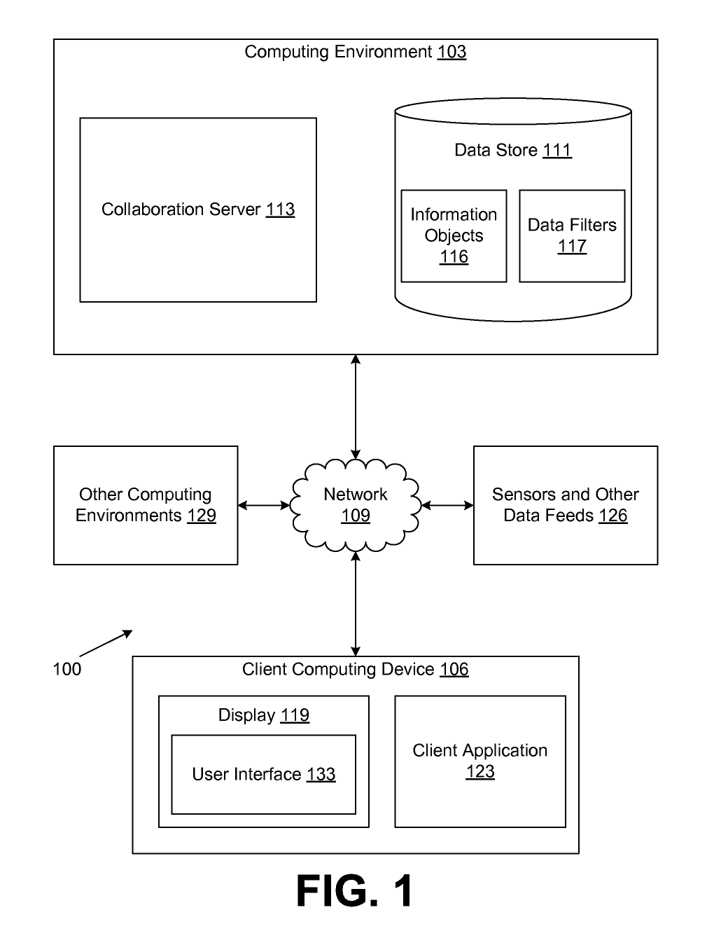

With reference to FIG. 1, shown is a networked environment 100 according to various embodiments. The networked environment 100 includes a computing environment 103 and a client computing device 106, which are in data communication with each other via a network 109. The network 109 includes, for example, the Internet, intranets, extranets, wide area networks (WANs), local area networks (LANs), wired networks, wireless networks, or other suitable networks, etc., or any combination of two or more such networks.

The computing environment 103 may comprise, for example, a server computer or any other system providing computing capability. Alternatively, the computing environment 103 may employ a plurality of computing devices that may be employed and that are arranged, for example, in one or more server banks, computer banks, or other arrangements. Such computing devices may be located in a single installation or may be distributed among many different geographical locations. For example, the computing environment 103 may include a plurality of computing devices that together may comprise a cloud computing resource, a grid computing resource, and/or any other distributed computing arrangement. In some cases, the computing environment 103 may correspond to an elastic computing resource where the allotted capacity of processing, network, storage, or other computing-related resources may vary over time.

Various applications and/or other functionality may be executed in the computing environment 103 according to various embodiments. Also, various data is stored in a data store 111 that is accessible to the computing environment 103. The data store 111 may be representative of a plurality of data stores 111 as can be appreciated. The data stored in the data store 111, for example, is associated with the operation of the various applications and/or functional entities described below.

The components executed on the computing environment 103, for example, include a collaboration server 113 and other applications, services, processes, systems, engines, or functionality not discussed in detail herein. The collaboration server 113 is executed to allow one or more users to create and share one or more information objects 116 and potentially other data.

The data stored in the data store 111 includes, for example, one or more information objects 116, one or more data filters 117, and potentially other data.

Information objects 116 are data storage objects structured to model data based on the relationships between individual pieces of information. As such, information objects 116 may comprise a set of associations with other information objects 116 to indicate data relationships. For example, a link between two information objects 116 may indicate a data dependency, a structural hierarchy, or other association of data modeled by two or more information objects 116. Information objects 116 may also be assembled and/or derived from other information objects to represent these relationships. As such most information objects 116 may be created from or represented by an assembly of other information objects 116.

However, some types or classes of information objects 116 may be reserved for particular types of data which cannot easily be represented as a combination of two or more other information objects 116. For example, repeating data blocks, such as images, sound, video, compressed data, and encrypted data, may require a reserved or unique instance of an information object 116 that functions as a wrapper for the underlying data. Continuous stream data, such as a stream of data from a sensor, may also require a unique or reserved instance of an information object 116 to represent the stream data because stream data has a beginning but not necessarily an end.

Certain classes or types of information objects 116 may also be reserved for various types of information primitives in some embodiments of the present disclosure. Information primitives are basic representations of information or data which may not be represented or broken into further subcomponents. For example, information primitives may include unformatted character strings, text, numbers, colors, simple shapes, and other such data.

Data filters 117 represent instructions, rules, or other suitable logic used by the collaboration server 113 for creating information objects 116 based at least in part on data provided from one or more sources. For example, data filters 117 may correspond to instructions, rules, or other suitable logic to be used by the collaboration server 113 for converting or importing a file or data encapsulated in a file into an information object 116. In some embodiments, the data filters 117 may also be used by the collaboration server 113 for exporting or converting an information object 116 into a file or file type for use with an application that is not configured to work with the collaboration server 113 or information objects 116.

The client computing device 106 is representative of a plurality of client computing devices that may be coupled to the network 109. The client computing device 106 may comprise, for example, a processor-based system such as a computer system. Such a computer system may be embodied in the form of a desktop computer, a laptop computer, personal digital assistants, cellular telephones, smartphones, set-top boxes, music players, web pads, tablet computer systems, game consoles, electronic book readers, or other devices with like capability. The client computing device 106 may include a display 119. The display 119 may comprise, for example, one or more devices such as liquid crystal display (LCD) displays, gas plasma-based flat panel displays, organic light emitting diode (OLED) displays, LCD projectors, or other types of display devices, etc.

The client computing device 106 may be configured to execute various applications such as a client application 123 and/or other applications. The client application 123 may be executed in a client computing device 106, for example, to access network content served up by the computing environment 103 and/or other servers, thereby rendering a user interface 133 on the display 119. To this end, the client application 123 may comprise, for example, a browser, a dedicated application, etc., and the user interface 133 may comprise a network page, an application screen, etc. The client computing device 106 may be configured to execute applications beyond the client application 123 such as, for example, email applications, social networking applications, word processors, spreadsheets, and/or other applications.

In addition, one or more sensors and other data feeds 126 may be in network communication with the collaboration server 113 or the client application 123. Sensors and other data feeds may comprise any electronic device capable of generating or recording data and transmitting the data to the collaboration server 113. Examples of sensors and other data feeds 126 include accelerometers, temperature sensors or thermostats, video or web cameras, microphones, noise sensors, pressure sensors, scales, timers, flow meters, light sensors, outputs or results of applications or programs, and other such devices or programs.

Finally, one or more other computing environments 129 may be connected to the computing environment 103, the client computing device 106, and/or one or more sensors and other data feeds 126 via the network 109. In various embodiments, the other computing environments 129 may be configured in a manner similar to that of the computing environment 103. In such an embodiment, the other computing environments 129 would include one or more collaboration servers 113, one or more data stores 111, and one or more information objects 116 stored in the other computing environments 129. In some embodiments, the client computing device 106 may be configured to work with collaboration servers 113 in the computing environment 103 or the other computing environments 129. In various embodiments, the collaboration server 113 may be able to interact with information objects 116 stored in the other computing environments 129.

Although FIG. 1 depicts a network-centric configuration representing a client-server model, this does not preclude other configurations. For example, in some embodiments, the client computing device 106 may be a computing device located within the computing environment 103. In various embodiments, the client application 123 may be located in the computing environment 103 along with the collaboration server 113, but the client application 123 may communicate or render the user interface 133 on the display 119 of the client computing device 106. In other embodiments, the collaboration server 113, the data store 111, and the client application 123 may all be located within a single computing device, such as the client computing device 106 or a single computer within the computing environment 103.

Next, a general description of the operation of the various components of the networked environment 100 is provided. To begin, the client application 123 makes a request for one or more information objects 116 or copies of information objects 116. For example, the client application 123 may request the information objects 116 for use in a presentation, report, or similar document. As another example, the client application 123 may request one or more information objects 116 for use in data analysis.

In response to the request of the client application 123, the collaboration server 113 determines if the requested information objects 116 are stored within the data store 111. If the requested information objects 116 are located within the data store 111, the collaboration server provides the requested information objects 116 to the client application 123. If the requested information objects 116 are not located within the data store 111, the collaboration server 113 determines whether the requested information objects 116 are located in other data stores 111 in other computing environments 129. If requested information objects 116 are found to be located in the other data stores 111 in other computing environments 129, the collaboration server 113 may request the information objects 116 from the other computing environments 129 and relay the requested information objects to the client application 123. However, in some embodiments, the collaboration server 113 may instead provide the location of the requested information objects 116 within the other computing environments 129 to the client application 123. In such embodiments, the client application 123 would then subsequently request and/or retrieve the information objects 116 from the other computing environments 129. If the requested information objects 116 cannot be found, the collaboration server 113 returns an error or other message to the client application 123. In some embodiments, the collaboration server 113 may further lock the requested information objects 116 in the data store 111 to prevent other client applications 123 from manipulating the requested information objects 116 to prevent the data stored by the information objects 116 from being concurrently modified and becoming incoherent over time.

Once the client application 123 receives copies of the requested information objects 116, the client application 123 uses or manipulates the requested information objects 116. Use and/or manipulation of the information objects 116 may be programmatic or the result of user intervention.

For example, the client application 123 may be a status monitor or similar application. In such an embodiment, the client application 123 may request one or more information objects 116, analyze the requested information objects 116, and create or modify a third information object 116 representing results of the analysis conducted on the requested information objects 116. In such embodiments, the client application 123 may further render a notification on within the user interface 133 on the display 119 of the client computing device 106.

As another example, the client application 123 may be a presentation application or similar application. In such an embodiment, the client application 123 may allow a user to display one or more information objects 116 within the user interface 133 as part of a presentation, manipulate one or more information objects 116 using the user interface 133, and create new information objects 116 representing new data or new relationships between two unrelated information objects 116. Such embodiments are described in further detail in related U.S. patent application Ser. No. 14/208,346, entitled “Visualization Interface for Information Object System,” filed on Mar. 13, 2014 and incorporated by reference herein in its entirety.

However, in other embodiments, the client application 123 may instead request from the collaboration server 113 a list of information objects 116 available for use by the client application 123. The list of information objects 116 may include all identifiers for each information object 116 that may be used or manipulated by the client application 123, as well as the type of data stored in the information object 116 and/or functions provided by the information object 116 for manipulating the information object 116 or querying the information object 116 for data stored within and/or encapsulated by the information object 116.

In response to the request of the client application 123, the collaboration server 113 determines if the requested information objects 116 are stored within the data store 111. If the requested information objects 116 are located within the data store 111, the collaboration server 113 provides the requested list of information objects 116 to the client application 123. If the requested information objects 116 are not located within the data store 111, the collaboration server 113 determines whether the requested information objects 116 are located in other data stores 111 in other computing environments 129. If requested information objects 116 are found to be located in the other data stores 111 in other computing environments 129, the collaboration server 113 may request the information objects 116 from the other computing environments 129 and include them in the list of information objects 116 provided to the client application 123. However, in some embodiments, the collaboration server 113 may instead provide the location of the requested information objects 116 within the other computing environments 129 to the client application 123. In such embodiments, the client application 123 would then subsequently request another list of information objects 116 from the other computing environments 129. If the requested information objects 116 cannot be found, the collaboration server 113 returns an error or other message to the client application 123.

After receiving the list of information objects 116, the client application 123 may then invoke one or more functions provided by the information object 116. For example, the client application 123 may invoke functions to update information stored in or encapsulated by the information object 116, retrieve a list of information objects 116 related to a particular information object 116, or invoke other functions provided by the information object 116 as will be further described herein.

In some embodiments, the client application 123 may render embodiments of one or more of the information objects 116 on the display 119 within the user interface 133. For example, the client application 123 may render multiple information objects 116 and illustrate the relationships between the different information objects 116 to provide the user with a map of the data represented by the various information objects 116. The client application 123 may further provide the ability for a user to explore the relationships between information objects 116 using the user interface 133. Such embodiments are described in further detail in related U.S. patent application Ser. No. 14/208,346, entitled “Visualization Interface for Information Object System,” filed on Mar. 13, 2014 and incorporated by reference herein in its entirety.

In some embodiments, the collaboration server 113 may also receive data from sensors and other data feeds 126. Sensors and other data feeds 126 may comprise any electronic device capable of generating or recording data and transmitting the data to the collaboration server 113. Examples of sensors and other data feeds 126 include accelerometers, temperature sensors or thermostats, video or web cameras, microphones, noise sensors, pressure sensors, scales, timers, flow meters, light sensors, outputs or results of applications or programs, and other such devices or programs.

The data received from the sensors and other data feeds 126 may include information objects 116 to be validated and/or stored in the data store 111 by the collaboration server 113. The data received from the sensors and other data feeds 126 may also include raw and/or non-encapsulated data which the collaboration server 113 transforms into or includes in information objects 116 stored in the data store 111. For example, a manufacturing machine connected to the collaboration server 113 may provide one or more information objects 116 that encapsulate and represent the manufacturing machine, status update related to the manufacturing machine, and similar data. In some embodiments, the collaboration server 113, the client application 123, or other applications with access to the information objects 116 may be able to issue commands to the sensors and other data feeds 126 by manipulating the information objects 116 related to the sensors and other data feeds. For example, a client application 123 may be able to issue commands to the manufacturing machine in the example described above via functions provided by the information object 116 representing the manufacturing machine.

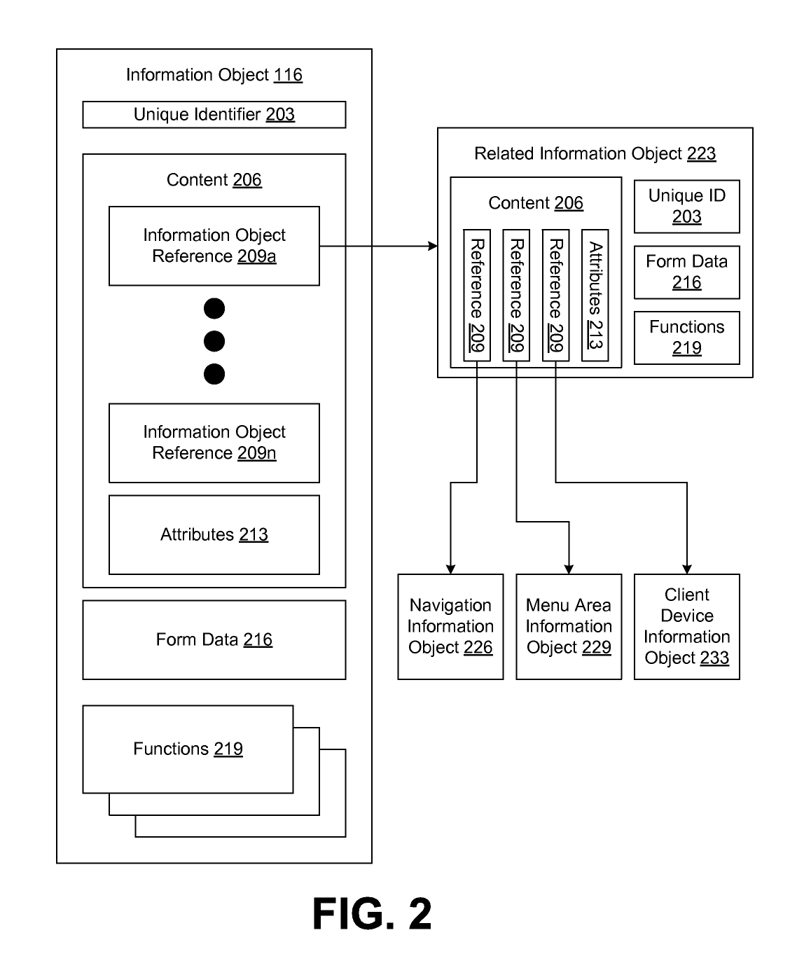

Referring next to FIG. 2, shown is a depiction of the data structure of an information object 116. Each information object 116 has at least one unique identifier 203, which uniquely identifies a particular instance of an information object 116 within the data store 111 (FIG. 1). Each information object 116 also includes content 206. Included in the content 206 of the information object 116 may be one or more information object references, such as information object reference 209a through information object reference 209n. The content 206 of the information object 116 may also include attributes 213 describing the information object 116. In addition, the information object 116 may include form data 216 and multiple functions 219.

A unique identifier 203 may be either a unique alpha-numeric number, such as the result of a cryptographic hash function, or may be a unique number generated by the collaboration server 113 (FIG. 1) when the information object 116 is created. For example, the collaboration server 113 may apply a cryptographic hash function, such as a version of the Secure Hash Algorithm, to an information object 116 to generate the unique identifier 203. In another example, the collaboration server 113 may increment a counter when the information object 116 is created and then set the unique identifier 203 equal to the value of the counter. In some embodiments, both approaches may be combined to minimize the risk of collisions from the cryptographic hash function or duplicate counter values resulting from integer overflow errors. For example, the counter may be incremented and the value prepended or appended to the result of a cryptographic has function to create a unique identifier 203.

The content 206 corresponds to the data represented by an information object 116, which may include one or more information object references 209a . . . n and/or one or more attributes 213. Each information object reference 209a . . . n points or links to a related information object 223. A related information object 223 may correspond to information that is a component of the information object 116 or is related to the information object 223 in some manner. For example, an information object 116 representing the country “Russia” may have an information object reference 209 linking the information object 116 to a related information object 223 corresponding to the city “Moscow.” The information object 116 representing “Russia” may also include a second information object reference 209 to a related information object 223 representing a list of countries and a third information object reference 209 to a related information object 223 representing “Communism.”

The attributes 213 of the information object 116 represent data stored within the information object 116 which may or not be directly presented to the user as main content. Attributes 213 of an information object 116 may include, for example, a username of a user who originally created the information object 116, a username of each user who has modified the information object 116, a timestamp recording the creation of the information object 116 and/or modification of the information object 116, a version of the interface standard supported by the information object 116 for use with the collaboration server 113 (FIG. 1) or the client application 123 (FIG. 1), language and/or cultural identification of the data represented by the information object 116, and other such data. In some instances, the attributes 213 themselves may be represented by other information objects 116. For example, a username of the creator of an information object 116 may be represented by an information object 116 that represents a user account.

The form data 216 corresponds to the data necessary to represent or display an information object 116 on a display 119 (FIG. 1). For example, form data 216 may represent the size of the information object 116 on the display 119, the location of the information object 116 on the display 119, a transparency value of the information object 116, whether to overlay or underlay the information object on the display 119 with respect to individual ones of the related information objects 223, and similar data or values. In some instances, the form data 216 may further specify the default placement of related information objects 223 on a display 119 relative to the information object 116. More generally, form data 216 describes how information object 116 and user interface options related to the information object 116, such as menus, menu options, and other user interface elements, are rendered on a display 119 of the client computing device 106. For multiple levels of encapsulation, such as where a first information object 116 encapsulates or links to one or more child or sibling information objects 116, multiple sets of form data 216 may be used on one information object 116 or multiple information objects 116, each with one set of form data 216 representing one level of information encapsulation or similar relationship.

The functions 219 correspond to programmatic interfaces, methods, or similar mechanisms through which the client application 123 (FIG. 1) or the collaboration server 113 may interact with or otherwise manipulate the information object 116. For example, the functions 219 may include functions for setting an information object 116 visible or invisible on a display 119, functions for editing or otherwise modifying the information object 116, functions for creating new information object references 209 or otherwise linking an information object 116 to a related information object 223. The functions 219 may also include functions for importing data into an information object 116 or exporting date from an information object 116 into another format, such as an application specific data file. In some embodiments, functions 219 may also allow for data to be added to and/or removed from an information object 116 as well as for data included within the information object 116 to be modified. In various embodiments, the functions 219 may also be called or used by the client application 123 or the collaboration server 113 to render the information objects 116 on the display 119 of the client computing device 106 according to the form data 216 within the corresponding information objects 116.

In some embodiments, one or more functions 219 may be provided by the information object 116 to permit analysis of the data included within the information object 116. For example, an information object 116 representing attendance at every baseball game for a baseball team during the regular baseball season may provide arithmetic functions 219 that provide the average attendance and the median attendance for the baseball team during the regular baseball season. More complicated data analysis functions may be provided by individual information objects 116 depending on the data stored in the information object 116 and the functions 219 provided by various implementations of the various embodiments described herein.

An information objection 116 or a related information object 223 may also have individual information object references 209 corresponding to user interface elements represented by information objects, such as a navigation information object 226, a menu area information object 229, and a client device information object 233. For example, the navigation information object 226 may describe or define the structure or relationships of the currently selected information object 116 in relation to other information objects 116. In some embodiments, the menu area information object 229 may describe or define various menu or other user interface 133 (FIG. 1) components which may be used to interact with the information object 116, such as editing, copying, or deleting the information object 116. In some embodiments, the menu area information object 229 may also provide for functionality to create new information objects 116. Further, in some embodiments, the client device information object 233 may contain user and system-wide settings, such as sound volume, display brightness, network connectivity settings, and other settings.

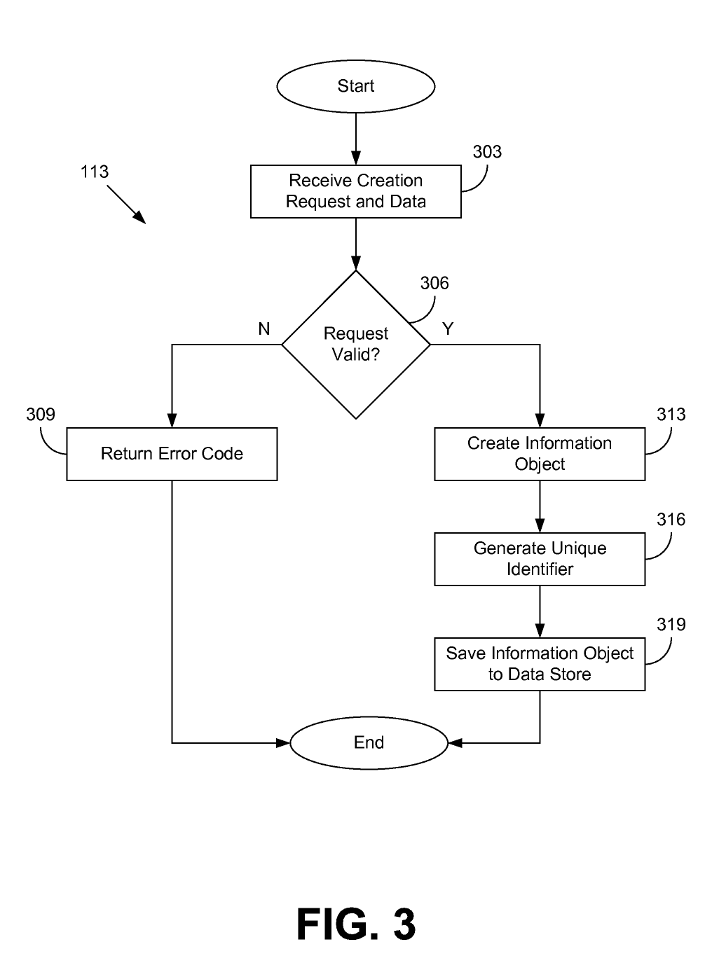

Referring next to FIG. 3, shown is a flowchart that provides one example of the operation of a portion of the collaboration server 113 according to various embodiments. It is understood that the flowchart of FIG. 3 provides merely an example of the many different types of functional arrangements that may be employed to implement the operation of the portion of the collaboration server 113 as described herein. As an alternative, the flowchart of FIG. 3 may be viewed as depicting an example of elements of a method implemented in the computing environment 103 (FIG. 1) according to one or more embodiments.

Beginning with box 303, the collaboration server 113 receives a request to create an information object 116 and data to be stored in the newly created information object 116. The request may be received from a number of sources, such as a client application 123 (FIG. 1) interacting with the collaboration server 113, a sensor or other data feed 126 (FIG. 1) that periodically sends data to the collaboration server 113, or other such source.

Proceeding next to box 306, the collaboration server 113 determines whether or not the request to create the information object 116 is valid. The collaboration server 113 may, for example, determine whether the requesting entity is authorized or has permission to create an information object 116. The collaboration server 113 may also verify that the data sent is valid data for the type of information object 116 that the collaboration server 113 has been requested to create. For example, if the collaboration server 113 has been requested to create an information object 116 for storing video data, the collaboration server 113 may check to determine that the data is indeed video data and not some other type of data. If the request is invalid, then execution proceeds to box 309. Otherwise, execution proceeds to box 313.

Moving on to box 309, the collaboration server 113 returns to the requestor an error message, error code, or an information object 116 representing the error. Execution subsequently ends.

Referring next to box 313, the collaboration server 113 creates the information object 116. The collaboration server 113 may allocate memory in the computing environment 103 (FIG. 1) to store and/or represent the information object 116 and its corresponding data structure. In those embodiments where an empty or “blank” information object 116 is required, execution proceeds to box 316. However, in those embodiments where an information object 116 is created in response to a request to store information, such as when the collaboration server 113 receives data from a client application 123 or a sensor and/or other data feed 126, this information is copied or placed into the content 206 (FIG. 2) of the information object 116 and the appropriate for form data 216 and functions 219 for the information object 219 are assigned to the information object 116. For example, where video data is to be saved within a newly created information object 116, the collaboration server 113 may also assign appropriate form data 216 and functions 219 to the information object for viewing, modifying, and/or otherwise interacting or manipulating the video data within the information object 116.

Proceeding to box 316, the collaboration server 113 generates a unique identifier 203 (FIG. 2) for the information object 116 and assigns the unique identifier 203 to the information object 116. The unique identifier 203 may be generated using any one or more of a number of approaches. For example, the unique identifier 203 may be a number within a sequence of numbers, such as would be generated using a counter or similar tracking mechanism. In such embodiments, the unique identifier 203 would be equal to a value of a counter. After assigning the unique identifier 203, the counter would then be incremented for use in creating a subsequent information object 116.

The unique identifier 203 may also be generated using one or more hash functions, such as various versions of the message digest algorithm (e.g. md4, md5, and similar algorithms), the secure hash algorithm (e.g., SHA-1, SHA-3, and similar algorithms), the RACE Integrity Primitives Evaluation Message Digest (RIPEMD) algorithm, and other such approaches. In such embodiments, the content 206 (FIG. 2) or other date may be used as an input to the hash function and the result of the may be used as the unique identifier 203. Other approaches may also be used to generate the unique identifier 203.

Moving on to box 319, the collaboration server 113 saves the information object 116 to the data store 111 (FIG. 1). Saving the information object 116 to the data store 111 may involve writing the information object 116 to memory, disk, or other such storage medium. In some embodiments, the information object 116 may be saved to a database or similar system. In such embodiments, the information object 116 may be written to the database as binary object, such as when binary data is stored within a relational database or other such database. After saving the information object 116 to the data store 111, execution ends.

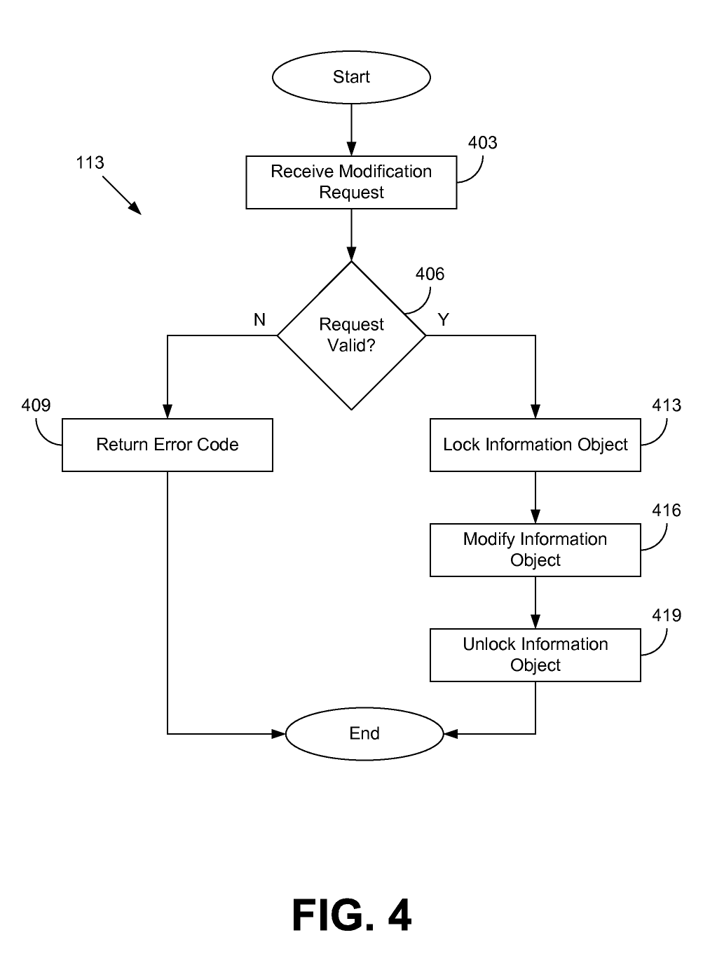

Referring next to FIG. 4, shown is a flowchart that provides one example of the operation of a portion of the collaboration server 113 according to various embodiments. It is understood that the flowchart of FIG. 3 provides merely an example of the many different types of functional arrangements that may be employed to implement the operation of the portion of the collaboration server 113 as described herein. As an alternative, the flowchart of FIG. 3 may be viewed as depicting an example of elements of a method implemented in the computing environment 103 (FIG. 1) according to one or more embodiments.

Beginning with box 403, the collaboration server 113 receives a request to modify an information object 116 and data to be added to, removed from, and/or modified within the information object 116. The request may be received from a number of sources, such as a client application 123 (FIG. 1) interacting with the collaboration server 113, a sensor or other data feed 126 (FIG. 1) that periodically sends data to the collaboration server 113, or other such source.

Proceeding next to box 406, the collaboration server 113 determines whether or not the request to modify the information object 116 is valid. The collaboration server 113 may, for example, determine whether the requesting entity is authorized or has permission to modify an information object 116. The collaboration server 113 may also verify that the data sent is valid data for the type of information object 116 that the collaboration server 113 has been requested to modify. For example, if the collaboration server 113 has been requested to modify an information object 116 for storing video data, the collaboration server 113 may check to determine that the data is indeed video data or appropriate metadata and not some other type of data. If the request is invalid, then execution proceeds to box 409. Otherwise, execution proceeds to box 413.

Moving on to box 409, the collaboration server 113 returns to the requestor an error message, error code, or an information object 116 representing the error. Execution subsequently ends.

Referring next to box 413, the collaboration server 113 locks the information object 116 to be modified. Locking the information object 116 may include using one or more control mechanisms to prevent other processes, applications, machines, and/or users from concurrently manipulating or modifying the information object 116 via the collaboration server 113. For example, the collaboration server 113 may make use of a token, mutex, spin lock, or other such mechanism to prevent other processes, applications, machines, and/or users from concurrently manipulating or modifying the information object 116. If the information object 116 has already been locked for modification, then the collaboration server 113 will pause execution until the information object 116 becomes unlocked. Otherwise, execution continues to box 416.

Proceeding to box 416, the collaboration server 113 retrieves the information object 116 to be modified from the data store 111 (FIG. 1) or otherwise accesses the information object 116. For example, the collaboration server 113 may use a unique identifier 203 (FIG. 2) of the information object 116 specified in the request to modify the information object 116 in order to locate, identify, and/or retrieve the information object 116 from the data store 111. The collaboration server 113 then proceeds to modify the content 206 (FIG. 2), information object references 209a-n (FIG. 2), the attributes 213 (FIG. 2), the form data 216 (FIG. 2), and/or the functions 219 (FIG. 2) of the information object 116 so that the information object 116 will reflect the changes and/or modifications requested.

Moving on to box 419, the collaboration server 113 unlocks the information object 116 so that other processes, applications, machines, and/or users will be able to modify or otherwise use the information object 116. Unlocking the information object 116 may include releasing the token, mutex, spin lock, or other such mechanism. Execution subsequently ends.

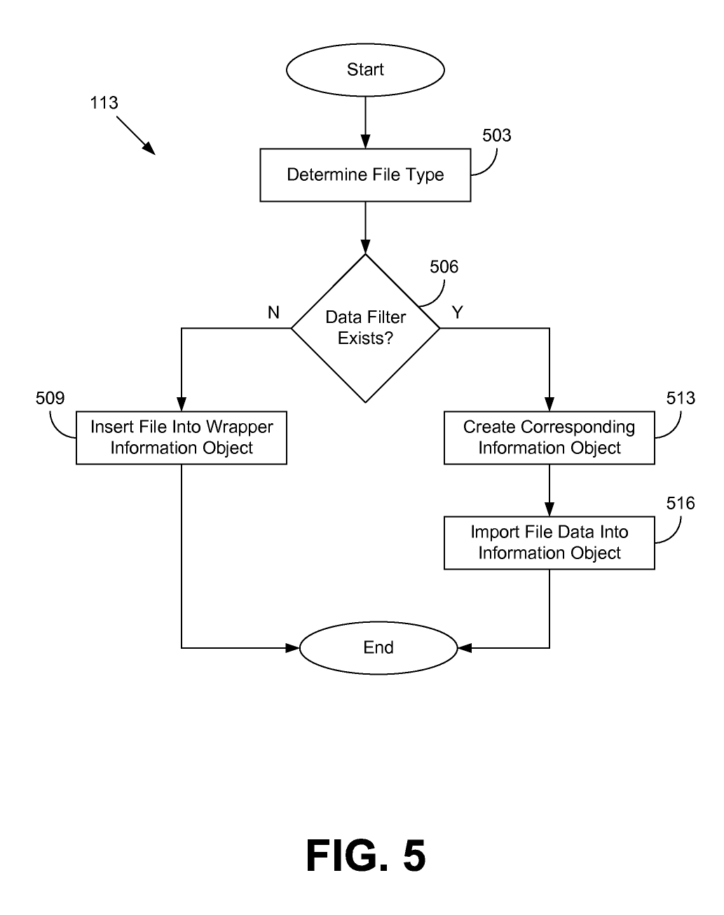

Referring next to FIG. 5, shown is a flowchart that provides one example of the operation of a portion of the collaboration server 113 according to various embodiments. It is understood that the flowchart of FIG. 3 provides merely an example of the many different types of functional arrangements that may be employed to implement the operation of the portion of the collaboration server 113 as described herein. As an alternative, the flowchart of FIG. 3 may be viewed as depicting an example of elements of a method implemented in the computing environment 103 (FIG. 1) according to one or more embodiments.

Beginning with box 503, the collaboration server 113 determines the type of file to be imported. The type of the file may be determined using one or more of several approaches. For example, the type of the file may be determined by checking to see if the name of the file includes a file extension matching a known file type. In other embodiments, the collaboration server 113 may examine the first few bytes or kilobytes of the file to determine whether the file data includes a file header or identifier values that matches a known file type. In other embodiments, the collaboration server 113 may identify the type of the file to be imported based on other data. For example, a user of a client application 123 (FIG. 1) may have identified the file type when sending the file to the collaboration server 113 for importing or a sensor or other data feed 126 may have similarly included an identification of the file type in a request to import a file sent to the collaboration server 113. Other approaches to identify the file type may be used in addition to or instead of the example approaches described above. Some embodiments may use one or more combinations of the approaches identified above to increase the accuracy and/or reliability of the identification of the file type.

Moving on to box 506, the collaboration server 113 determines whether or not an appropriate data filter 117 (FIG. 1) exists for creating an information object 116 for the type of file received. If no corresponding data filter 117 exists, executing proceeds to box 509. If a corresponding data filter 117 is found for the type of file received, then execution instead proceeds to box 513.

Proceeding to box 509, the collaboration server 113 creates a base information object 116 and inserts the file into the information object 116. The base information object 116 therefore acts as a wrapper permitting the file received to be stored in the data store 111 and available in response to future requests to the collaboration server 113 for the file or data in the file. The created information object 116 is considered a base information object 116 insofar as the information object 116 may not include any attributes 213 (FIG. 2), form data 216 (FIG. 2), or functions 219 (FIG. 2) that would be included in an information object 116 for a specific type of file or data. For example, an information object 116 created for a bitmap image file may include attributes 213 related to the dimensions of the picture represented by the bitmap image file, the particular bitmap encoding used in the bitmap image file, and other image specific attributes 213. In contrast, a base information object 116 may have the bare minimum of attributes 213 necessary to store the file within the information object 116. After storing the file in the base information object 116, execution subsequently ends.

Referring next to box 513, the collaboration server 113 creates an information object 116 according to the requirements and/or rules specified in the identified data filter 117. This includes reserving, in memory, sufficient space for the content 206 (FIG. 2) of the information object 116 and including within the information object 116 the functions 219 and form data 216 specified by the data filter 117. A unique identifier 203 (FIG. 2) is also assigned to the newly created information object 116 at this point. Any information object references 209 (FIG. 2) to related information objects 223 (FIG. 2) are also created at this time.

Moving on to box 516, the collaboration server 113 examines and/or parses the file to extract data from the file specified by the data filter 117. The extracted data is then copied and/or inserted into information object 116 content 206 as required by the data filter 117. Execution subsequently ends.

It should be further noted that although the operations described above are discussed within the context of creating information objects 116 from files, similar operations would apply to creating information objects 116 from non-file data. For example, one or more information objects 116 could be created based on a data stream, such as an audio or a video stream, using similar approaches to those described above.

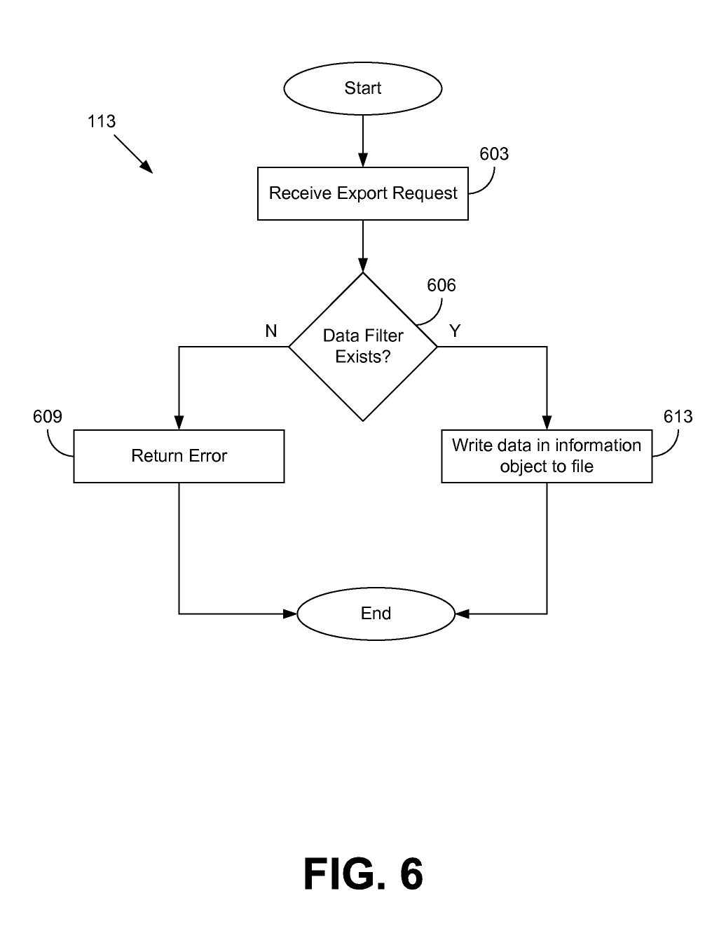

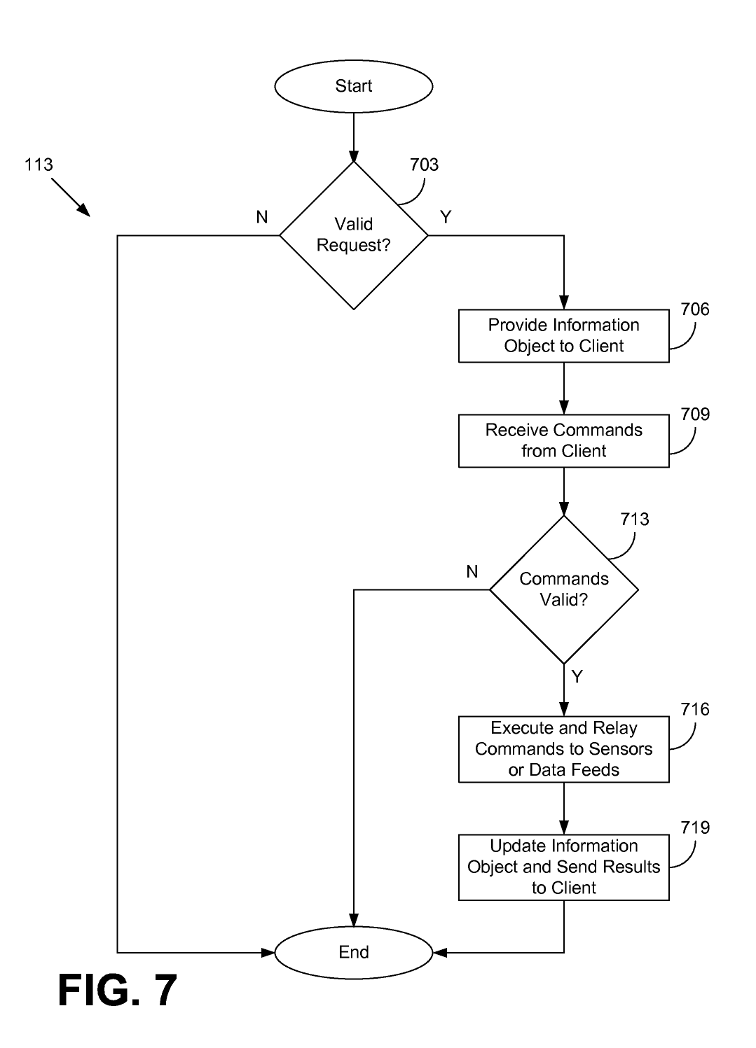

Referring next to FIG. 6, shown is a flowchart that provides one example of the operation of a portion of the collaboration server 113 according to various embodiments. It is understood that the flowchart of FIG. 3 provides merely an example of the many different types of functional arrangements that may be employed to implement the operation of the portion of the collaboration server 113 as described herein. As an alternative, the flowchart of FIG. 3 may be viewed as depicting an example of elements of a method implemented in the computing environment 103 (FIG. 1) according to one or more embodiments.

Beginning with box 603, the collaboration server 113 receives a request to export an information object 116 to a file. The request may identify the type of file to be exported or the information object 116 may specify the type of file to which the information object 116 may be exported. For example, an information object 116 representing audio information may specify that the audio information represented by the information object may be exported to a specific format and/or file type. The request may be received from one or more sources, including a client application 123 (FIG. 1), a sensor or other data feed 126 (FIG. 1), or some other source.

Moving on to box 606, the collaboration server 113 determines whether a data filter 117 exists for the corresponding file type for the file to which the information object 116 will be exported. If no corresponding data filter 117 exists, executing proceeds to box 609. If a corresponding data filter 117 is found for the type of file received, then execution instead proceeds to box 613.

Referring next to box 609, the collaboration server 113 returns to the requestor an error message, error code, or an information object 116 representing the error. Execution subsequently ends.

Proceeding on to box 613, the collaboration server 113 writes the contents 206 of the information object to a file according to the specifications of the data filter 117. For example, an information object 116 representing an image may have the image data stored in the contents 206 of the information object 116 to a bitmap file, but data such as the form data 216 or functions 219 would not be written to the bitmap file. Execution subsequently ends.

Referring next to FIG. 7, shown is a flowchart that provides one example of the operation of a portion of the collaboration server 113 according to various embodiments. It is understood that the flowchart of FIG. 3 provides merely an example of the many different types of functional arrangements that may be employed to implement the operation of the portion of the collaboration server 113 as described herein. As an alternative, the flowchart of FIG. 3 may be viewed as depicting an example of elements of a method implemented in the computing environment 103 (FIG. 1) according to one or more embodiments.

Beginning with box 703, collaboration server 113 validates a request received from the client application 123 (FIG. 1) for an information object 116 (FIG. 1) representing a sensor or other data feed 126 (FIG. 1). To validate the request, the collaboration server 113 may determine whether or not the client application 123 has permission to access the requested information object 116, determine whether the requested information object 116 exists, determine whether the request is properly formatted, and/or make other such determinations. If the request is determined not to be valid, execution ends. Otherwise, execution proceeds to box 706.

Proceeding to box 706, the collaboration server 113 provides the information object 116 to the client application 123. For example, the collaboration server 113 may provide a copy of the information object 116 to the client application 123 for the client application 123 to manipulate locally on the client computing device 106 (FIG. 1). In such embodiments, the collaboration server 113 may lock the information object 116 so that other client applications 123 cannot manipulate the information object 116 in order to prevent the information object 116 from entering an incoherent state as a result of multiple and possibly conflicting modifications by different client applications 123. In other embodiments, the collaboration server 113 may expose one or more functions 219 (FIG. 2) of the information object 116 and/or the content 206 of the information object 116 to the client application 123.

Moving on to box 709, the collaboration server 113 receives one or more commands from the client application 123 to be performed by the sensor or other data feed 126. In those embodiments where the collaboration server 113 had previously provided a copy of the information object 116 to the client application 123, the commands may be received when the client application 123 returns an updated version of the information object 116 to the collaboration server 113. The changes to the information object 116 would represent the commands to be executed by the sensor or other data feed 126. In those embodiments where the collaboration server 113 exposed one or more functions 219 and/or the content 206 of the information object 116, the client application 123 may provide a list or series of functions 219 to be called or executed by the collaboration server 113 on the information object 116. For example, the client application 123 may use a remote procedure call (RPC) or similar mechanism to invoke a particular function 219 or series of functions 219 of the information object 116.

Referring next to box 713, the collaboration server 113 determines whether the commands received from the client application 123 are valid. For example, the collaboration server 113 may determine whether the client application 123 has provided appropriate arguments to any functions 219 provided by the information object 116, whether client application 123 has permission to call or invoke the specific functions 219 used, and/or other similar determinations. If the collaboration server 113 determines that one or more of the commands are invalid, then execution ends. If the collaboration server 113 determines that all of the commands received from the client application 123 are valid, then execution proceeds to box 716.

Proceeding to box 716, the collaboration server 113 executes the commands received from the client application 123 and relays any necessary instructions to the sensor or other data feed 126 represented by the information object 116. For example, the collaboration server 113 may execute the necessary functions 219 to update the content 206 of the information object 116 stored in the data store 111. To the extent that one or more commands correspond to one or more functions 219 that instruct or otherwise require the sensor or other data feed 126 to perform a specific action, the collaboration server 113 will relay any required instructions or commands to the sensor or other data feed 126.

For example, the client application 123 may have correctly invoked a “PowerOff' function 219 provided by an information object 116 that represents a manufacturing machine. In response, the collaboration server 113 may execute that “PowerOff' function 219 of the information object 116 to set an attribute 213 of the information object 116 equal to a value or other representation of a “Shutdown” state. The collaboration server 113 may then send a command to the manufacturing machine to begin a power down routine. In some embodiments, the command may correspond to a command accessible to the collaboration server 113 by an application programming interface (API) exposed by the sensor or other data feed 126, such as the manufacturing machine. In such embodiments, the collaboration server 113 may invoke the command using a remote procedure call (RPC) or similar mechanism.

Moving on to box 719, the collaboration server 113 will update the information object 116, if necessary, after sending any commands to the sensor or other data feed 126. For example, in response to receiving an RPC from the collaboration server 113, the sensor or other data feed 126 may respond with a result, error code, or other return value. In such instances, the collaboration server 113 may update the information object 116 to reflect the received result, error code, or other return value. The collaboration server 113 then sends the results of the operation to the client application 123. For example, the collaboration server 113 may provide an updated version of the information object 116 to the client application 123, a return or result code to the client application 123 indicating the result of the function or functions 219 invoked by the client application 123, or other such results to the client application 123. Execution subsequently ends.

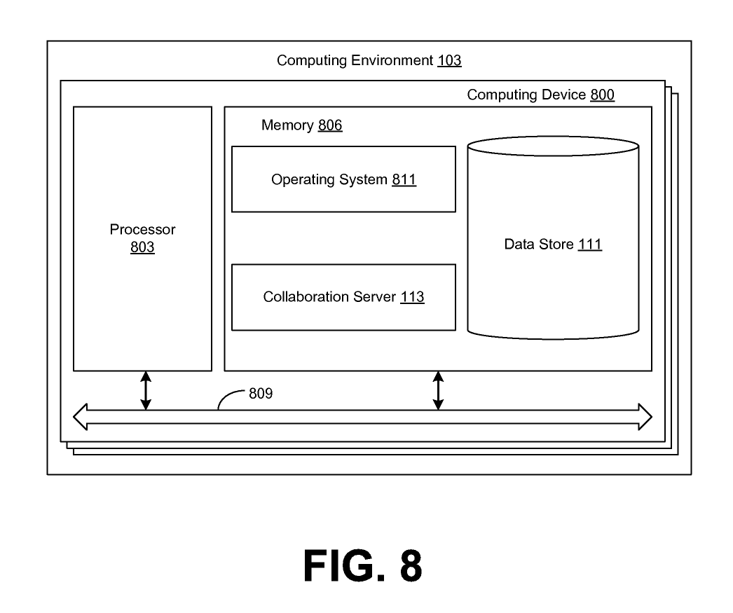

With reference to FIG. 8, shown is a schematic block diagram of the computing environment 103 according to an embodiment of the present disclosure. The computing environment 103 includes one or more computing devices 800. Each computing device 800 includes at least one processor circuit, for example, having a processor 803 and a memory 806, both of which are coupled to a local interface 809. To this end, each computing device 800 may comprise, for example, at least one server computer or like device. The local interface 809 may comprise, for example, a data bus with an accompanying address/control bus or other bus structure as can be appreciated.

Stored in the memory 806 are both data and several components that are executable by the processor 803. In particular, stored in the memory 806 and executable by the processor 803 are the collaboration server 113, and potentially other applications. Also stored in the memory 806 may be a data store 111 and other data. In addition, an operating system 811 may be stored in the memory 806 and executable by the processor 803.

It is understood that there may be other applications that are stored in the memory 806 and are executable by the processor 803 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 806 and are executable by the processor 803. In this respect, the term “executable” means a program file that is in a form that can ultimately be run by the processor 803. Examples of executable programs may be, for example, a compiled program that can be translated into machine code in a format that can be loaded into a random access portion of the memory 806 and run by the processor 803, source code that may be expressed in proper format such as object code that is capable of being loaded into a random access portion of the memory 806 and executed by the processor 803, or source code that may be interpreted by another executable program to generate instructions in a random access portion of the memory 806 to be executed by the processor 803, etc. An executable program may be stored in any portion or component of the memory 806 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 806 is defined herein as including both volatile and nonvolatile memory and data storage components. Volatile components are those that do not retain data values upon loss of power. Nonvolatile components are those that retain data upon a loss of power. Thus, the memory 806 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 803 may represent multiple processors 803 and/or multiple processor cores and the memory 806 may represent multiple memories 806 that operate in parallel processing circuits, respectively. In such a case, the local interface 809 may be an appropriate network that facilitates communication between any two of the multiple processors 803, between any processor 803 and any of the memories 806, or between any two of the memories 806, etc. The local interface 809 may comprise additional systems designed to coordinate this communication, including, for example, performing load balancing. The processor 803 may be of electrical or of some other available construction.

Although the collaboration server 113, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts of FIGS. 3-7 show the functionality and operation of an implementation of portions of the collaboration server 113. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 803 in a computer system or other system. The machine code may be converted from the source code, etc. If embodied in hardware, each block may represent a circuit or a number of interconnected circuits to implement the specified logical function(s).

Although the flowcharts of FIGS. 3-7 show a specific order of execution, it is understood that the order of execution may differ from that which is depicted. For example, the order of execution of two or more blocks may be scrambled relative to the order shown. Also, two or more blocks shown in succession in FIGS. 3-7 may be executed concurrently or with partial concurrence. Further, in some embodiments, one or more of the blocks shown in FIGS. 3-7 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the collaboration server 113, that comprises software or code can be embodied in any non-transitory computer-readable medium for use by or in connection with an instruction execution system such as, for example, a processor 803 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the collaboration server 113, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 800, or in multiple computing devices in the same computing environment 103. Additionally, it is understood that terms such as “application,” “service,” “system,” “engine,” “module,” and so on may be interchangeable and are not intended to be limiting.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A non-transitory computer-readable medium embodying a program executable in at least one computing device, comprising:
code that creates an information object in response to receiving a request to store data from an application, wherein the request to store data comprises a first file and a first file type, or a data stream and an identification of a data source for the data stream and the information object is created based at least in part on the first file type or the identification of the data source;
code that modifies the information object in response to receiving a request to modify the information object from the application, wherein the information object is locked while the information object is modified;
code that provides a copy of the information object to the application in response to receiving a request for the information object from the application; and
code that exports the information object to a second file in response to receiving a request to export the information object, wherein the request to export the information object specifies a second file type for the second file.

2. The non-transitory computer-readable medium of claim 1, wherein the information object encapsulates:
content data comprising a plurality of attributes related to the information object and a reference to another information object;
form data describing how the information object is to be rendered within a user interface of the application; and
a function for manipulating the information object.

3. The non-transitory computer-readable medium of claim 1, wherein the first file and the first file type are associated with a first application and the second file and the second file type are associated with a second application.

4. A system, comprising:
a computing device; and
a first application executed in the computing device, the application comprising:
logic that creates an information object in response to receiving a request to store data from a second application;
logic that modifies the information object in response to receiving a request to modify the information object from the second application; and
logic that provides a copy of the information object to the second application in response to receiving a request for the information object from the second application.

5. The system of claim 4, wherein the information object comprises content data, the content data comprising at least one of an attribute related to the information object or a reference to another information object.

6. The system of claim 4, wherein the information object comprises form data describing how the information object is to be rendered within a user interface of a client application executing on another computing device.

7. The system of claim 4, wherein the information object comprises a function for manipulating the information object, wherein the function may be invoked by either the application or a client application executing within a client computing device.

8. The system of claim 7, wherein the logic that modifies the information object invokes the function of the information to modify the information object.

9. The system of claim 4, wherein the logic that provides a copy of the information object to the second application in response to receiving a request for the information object from the second application further comprises:
logic that determines whether the information object is located in a memory of the computing device;
logic that provides the information object to the second application in response to determining that the information object is located in the memory of the computing device; and
logic that sends a query to a third application executing in another computing device in response to determining that the information object is not located in the memory of the computing device, wherein the query requests that the third application determine whether the information object is located in a memory of the second computing device.

10. The system of claim 9, wherein the logic that provides a copy of the information object to the second application in response to receiving a request for the information object from the second application further comprises:
logic that retrieves the information object from the another computing device when the third application responds to the query with an indication that the information object is located in the memory of the second computing device; and
logic that provides the information object to the second application in response to retrieving the information object from the another computing device.

11. The system of claim 9, wherein the logic that provides a copy of the information object to the second application in response to receiving a request for the information object from the second application further comprises:
logic that provides the second application with a location of the information object when the third application responds to the query with an indication that the information object is located in the memory of the second computing device.

12. A method, comprising:
creating, via a computing device, an information object in response to receiving a request to store data from an application;
modifying, via the computing device, the information object in response to receiving a request to modify the information object from the application; and
providing a copy of the information object, via the computing device, to the application in response to receiving a request for the information object from the application.

13. The method of claim 12, wherein the request to store data comprises a file and a file type.

14. The method of claim 13, wherein creating, via the computing device, the information object in response to receiving the request to store data from the application further comprises:
identifying, via the computing device, a rule for creating the information object, wherein the rule corresponds to the file type;
creating, via the computing device, the information object according to the rule; and
copying, via the computing device, data from the file into the created information object.

15. The method of claim 12, wherein the request to store data comprises a stream of data.

16. The method of claim 15, wherein creating, via the computing device, the information object in response to receiving the request to store data from the application further comprises:
identifying, via the computing device, a data source for the stream of data; and
creating, via the computing device, a plurality of information objects based at least in part on the data source, wherein each one of the plurality of information objects encapsulates at least a portion of the stream of data.

17. The method of claim 12, wherein the information object encapsulates at least one of:
content data comprising a plurality of attributes related to the information object and a reference to another information object;
form data describing how the information object is to be rendered within a user interface an application; or
a function for manipulating the information object.

18. The method of claim 12, wherein providing the copy of the information object, via the computing device, to the application in response to receiving the request for the information object from the application further comprises:
determining, via the computing device, a data store in which the information object is currently stored; and
providing, via the computing device, a path to the data store to the application.

19. The method of claim 12, further comprising exporting, via the computing device, the information object to a file in response to receiving a request from the application to export the information object to the file.

20. The method of claim 19, wherein exporting, via the computing device, the information object to the file in response to receiving the request from the application to export the information object to the file further comprises:
identifying, via the computing device, a target file type of the file;
identifying, via the computing device, a rule for converting the information object to the target file type;
creating, via the computing device, the file; and
copying, via the computing device, a least a portion of content encapsulated within the information object from the information object to the created file.
